(19) United States
(12) Patent Application Publication
(10) Pub. No.: US 2006/0212912 A1
(43) Pub. Date: Sep. 21, 2006

(54) Method and device for distributing video information

(76) Inventor: Roger Bergstrom, Kiruna (SE)

Correspondence Address: DENNISON, SCHULTZ & MACDONALD, 1727 KING STREET, SUITE 105, ALEXANDRIA, VA, 22314, US

(21) Appl. No.: 10/543,540

(22) PCT Filed: Jan. 21, 2004
(86) PCT No.: PCT/NO04/00013

§ 371 Date: Jul. 27, 2005

(30) Foreign Application Priority Data
Feb. 4, 2003 (NO) 20030544

(51) Int. Cl. H04N 7/173

(52) U.S. Cl. 725/86

(57) ABSTRACT

Method and device for distribution of video information over single or multiple distribution networks, in particular TV-networks, where secondary programs of commercial character are sent parallel to, or in between, a series of main programs, where each program is supplied with a program code (PID-code) at a central location, which code contains information about the identity or character of the program as the basis for a selection of programs that will be presented to a recipient. In each receiver, one or more criteria for the selection of secondary programs are stored, and the selection criteria or selection codes are generated as a result of the viewer's reaction to a corresponding number of questions which are presented on the viewer's screen, on the basis of a program that is sent out from a central control unit. The selection criteria are stored only in a separate receiver, as the questions regard demographic circumstances and/or interests of the TV viewer.

The invention relates to a method, as indicated in the introductory part of claim 1, for the transmission and distribution of video information through a distribution network, in particular a television network, and an apparatus for performing such transmissions.

### BACKGROUND

Distribution of information that is paid by a sender (commercials), has become a significant part of TV and radio broadcasting, and is also a substantial part of the Internet. The incomes from such information paid by a sender, form a substantial part of the program costs.

This has led to considerable efforts in organizing the transmissions, so that they are adapted as appropriately as possible to the interests and needs of the recipients. So far, this has mainly led to the connection according to program, in such a way that the information paid by a sender has been connected to other programs, which have had a corresponding viewer/listener profile.

Until now, a satisfactory technical system for connecting the information paid by a sender to special groups of recipients, has not been available.

It is known to code transmissions from different senders, with a code that contains information about the character of the program. With appropriate filters and selection means in the receivers, the viewers can choose a program type and possibly particular programs, which are to be received, viewed and/or recorded. This solution is intended for normal programs, and thus is not arranged for reception of commercials. This, among other things, is because commercials, due to their character, normally do not lead to interest for individual selection.

### OBJECT

The main purpose of the invention is to provide a method and an apparatus for transmitting and distributing short-duration TV-transmissions, where distribution of the type of information occurs mainly automatically, on the basis of the interests of the potential viewers. Short-duration means a piece of program with a duration between a few seconds and 2-3 minutes.

### THE INVENTION

The invention is stated in claim 1. By means of the present invention, it is possible to control a stream of information in such a way that it becomes selective in accordance with the interests of the users, without the users needing to give information concerning their desires, priorities, or interests/hobbies.

In claim 2 an advantageous detail of the present invention is stated.

In claim 3 an arrangement for performing the method according to the invention is stated.

In claims 4 to 6 advantageous details of the arrangement are indicated.

### EXAMPLE

The invention is described below, with reference to the drawings, where

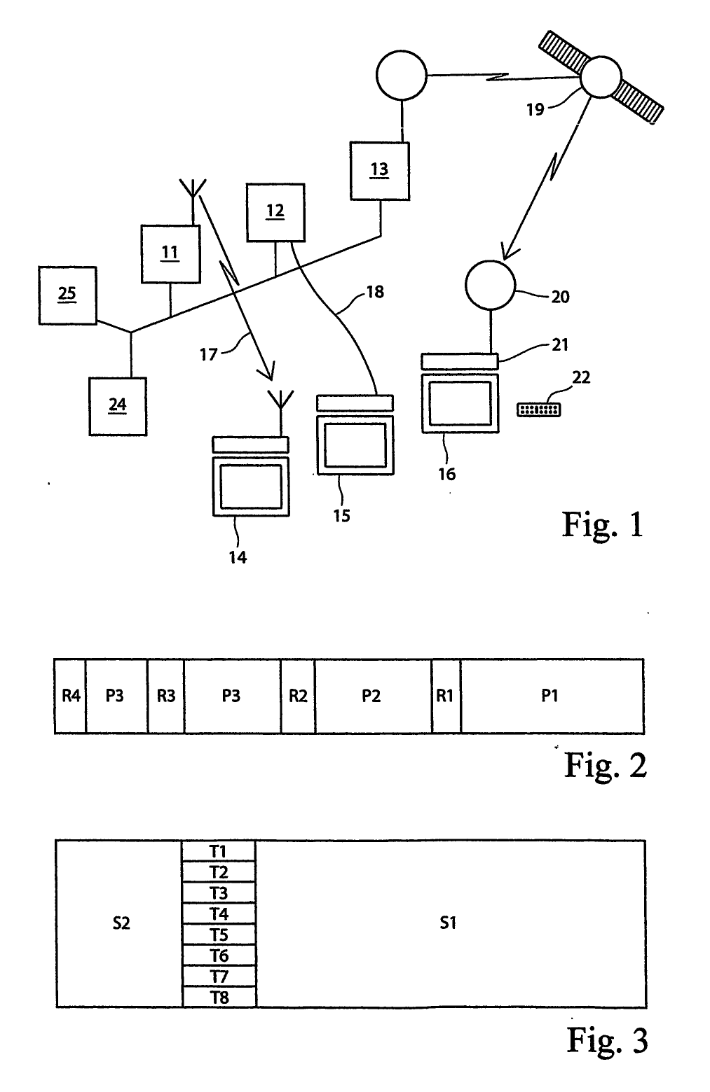

FIG. 1 is a schematic sketch of a possible “communication universe” with transmitters and receivers,

FIG. 2 is a schematic representation of a normal signal course, with a series of main programs and inserted commercials,

FIG. 3 is a schematic representation of a signal course according to the invention, with a main program that is followed by a number of secondary programs or commercial programs, while

FIG. 4 is a flow diagram that illustrates the process of installing a user profile in the users receiver system.

FIG. 1 shows a number of TV-transmitters 11, 12, 13, of which each disposes a channel for distribution to receivers 14, 15, 16, either through land-based wireless transmission 17, cable 18, or satellite 19 with a satellite dish 20. Each receiver is connected to a digital receiver, in particular, a so-called “DVB-SetTop-box” 21, which contains circuits for signal processing and program storage. In the example, the digital receiver 21 contains data processing and storage capacity similar to that of a computer. But it may also be a program processing circuit without memory. Each digital receiver 21 can be controlled with a hand-held programming unit or “remote control” 22.

The signals from the transmitters 11-13 may contain series of TV-programs. Normally a number of TV-programs are broadcast simultaneously. In cases where the operation is partially or completely funded by commercials, program pieces, which are paid for by sponsors or advertisers, are sent between the main programs.

Such a program sequence is illustrated in FIG. 2, with a series of main programs P1, P2, P3, in between, or into which, shorter program pieces R1, R2, R3, R4 of commercial or information character, are inserted. These program pieces can be sequences with a length of some seconds to some minutes, possibly put together from a number of short program pieces. Each of the short program pieces or secondary programmes R1, R2 etc. is coded with an identification code that is assigned to a structuring system. In theory, this structuring system may comprise an arbitrary number of groups. However, in practice, 3 to 30 groups have proven to be particularly advantageous.

An alternative to the simultaneous transmission of the advertisement programs is that a transmission can be performed parallel to the main program, for local storage. This can be according to DVB/MHP standards or manufacturer-specific solutions, for instance OpenTV or Media Highway. It is then presumed digital receivers with storage capacity for TV-programs are employed. In this case, presentation of the advertisement program will be triggered by a signal, which is transmitted together with the normal broadcasting signal, a so-called “VBI-signal”. The advertisement triggering signal is defined in the teletext-module under the DVB-standard, and corresponds to the old VBI-signal, which was used for analog transmissions.

FIG. 3 shows a schematic section of such a program sequence, according to an embodiment of the invention. A main program S1 is shown, which is followed by a simultaneous series of short program pieces T1-T8. Each program T1-T8 can have independent content of advertisement or information character, with, or without, a defined sender, but with a client, which gives a compensation for the broadcast. An electronic identifier, for instance of the PID-type according to the DVB-standard, is connected to each of the signals S1 and T1-T8. This can be generated by a PID-code-coordinator 25, shown in FIG. 1. Each platform has its own PID-numbering. Hence, in the coordinator there must exist one PID-table per transmitting system.

With such an identifier it is possible for a digital receiver 21, which is correspondingly programmed, to identify incoming program units, for instance, to control presentation or recording, according to the user profile. This can be performed without active influence or programming from the viewer.

The digital receivers 21 contain circuits for storing a program that can control presentation and recording of incoming programs. According to the invention, such a control program can be configured by each single user in a particular manner.

It is known to identify normal programs with electrical codes and supply receiver sets with filter circuits that can be controlled by the viewers, so that particular programs can be captured for presentation and/or recording.

Differing from this, the invention presumes that the viewers get a program transmitted, either remotely or by demand download, which can be used to control the selection of the program pieces, and which will be supplied to all recipients with the appropriate equipment for this purpose.

From a control centre 24 a DVB control program can be transmitted to all receivers in a part of the illustrated universe (FIG. 1). This DVB control program is downloaded into the digital receivers 21 and intervenes in the control of the program reception.

According to a preferred embodiment, the DVB control program can be adapted to establish reception blocking for general TV reception, which can be removed by the input of answers to a series of questions concerning a consumers preferences. This function can be implemented using known programming techniques.

FIG. 4 shows a block diagram that illustrates the manner of operation or functionality of an embodiment of the invention:

At 40, a control program is downloaded from the control centre 24 (FIG. 1), which is coded for a digital receiver. The download is performed through the same transmission channel as is used for the ordinary TV programs.

At 41, the user starts the reception. The question is asked, whether it is the first time the system is started after the download of the program. This question can produce two answers, yes or no.

At 42, a response “yes” triggers a demand for answering a number of questions concerning demography and/or interests of the viewer.

At 43, answers for the questions are loaded, of which some may be obligatory, and others voluntary. Answering of the obligatory questions will be necessary in order to continue the start-up process. The questions can be suitably presented on the TV-screen as a choice between alternatives, and can be answered by operating an appropriately modelled remote control.

At 44, the answers are stored in the digital receiver as the basis for later program selection of the secondary programs, especially the advertisement programs.

Moreover, a signal is transmitted to the control centre 24, indicating that the customer has installed the system and answered the obligatory questions that indicate the profile of interests. The transmission to the control centre 24 can be performed with an SMS-message. The SMS-message, which shall be sent in, can be presented on the TV-screen as a code, and will contain an identification of the receiver, so that only one message can be sent from each receiver. This terminates the initiation process. It is known how SMS-communication can be connected to the control centre 24.

To get an overview of the use of commercials, the system can select a number of viewers by statistical selection. These viewers will be asked if they will send in a code via SMS. This code contains their actual choice of programs during one program day, and is automatically generated and shown on the TV-screen together with the inquiry.

If step 41 yields “no” to the question on whether it is the first time the system is started, it will, in step 45, be considered whether the timelapse since the last acknowledgement exceeds a certain period; for instance two months, or, if it is time to change the recipient profile for a particular reason, for instance, because of seasonal conditions; or because of exceptional conditions that makes it desirable to have the possibility to overrule the ordinary commercial selection, for instance because of a situation that triggers off specific commercial requirements, step 42 will be activated.

If step 45 yields a “no”, a new activation can be triggered off in step 46, by asking the user whether or not he/she wants to change his/her profile of interest, and then initiating change of this.

At step 47, the digital receiver is released for presentation of TV-signals, in the same manner as is done by going through step 44.

By means of the questions, which must be answered in step 43, the TV-user's profiles of interest are identified and stored locally in the digital receiver 21, inaccessible to persons other than the user who has answered the questions.

The questions may concern gender, age, and interests. Answering the part concernig interests can be connected to a limited number of alternatives, such as areas of consumption (for instance parents of young children, sports, hunting and fishing, housing and interior design, personal hygiene, cars, clothing and season-related offers).

Hence, the programs that report the individual profile of interest, can be updated in different ways. Firstly, the users themselves can perform updates, i.e. reprogramming, with the remote control 22, by entering step 46. In addition, it is possible to send out messages together with the program signal, with a suggestion for reprogramming, from a transmission centre 24 that is connected to the senders 11-13. This will trigger off step 45. This means that the user, for instance, can be sent season-dependent updates from the transmission centre 24, for example at the beginning of Christmas trading or the summer holidays.

The “user profile”, which is installed in the digital receiver 21 will control the selection of the advertisement programs T1-T8, so that these are shown selectively. In this manner, a substantially increased user interest, and hence response is acheived, compared to the existing advertisement broadcasting, which is substantially controlled by channel, program type and viewing time.

In many cases, a TV-receiver is used by multiple viewers with different profiles of interest. It may therefore be desirable to operate the system with varying profiles for selection of advertisement programs, without it being possible for the user to gain control, for instance with a remote control.

Thus, in a modified embodiment of the invention, it may be advantageous to have algorithms that can select programs to present, on the basis of season, time of the day and locally stored profile, as well as geographic location so that the programs are adjusted to the expected viewer interests as well as possible, which can vary during one program day. This can be done with a selection in the local digital receiver or the “SetTop-box”.

The algorithm can also have locally stored statistics on the types of commercials that are seen most often and which are seen less often, i.e. a register of the least and most switching to other channels in the period where the advertisement programs of different categories are shown.

1. Method for distribution of video information over single or multiple distribution networks, in particular TV-networks, where secondary programs of commercial character are sent parallel to, or in between, a series of main programs, where each program is supplied with a program code (PID-code) at a central location, said code contains information about the identity or character of the program, as the basis for a selection of programs that will be presented to a recipient, characterized in that in each receiver, one or more criteria for the selection of secondary programs are stored, as the selection criteria, or selection codes, are generated as a result of the viewer's reaction to a corresponding number of questions, which are presented on the viewer's screen on the basis of a program that is sent out from a central control unit (24), so that the selection criteria are stored in a separate receiver, and there only, as the questions regard demographic circumstances and/or interests of the TV-viewer.

2. Method according to claim 1, characterized in that codes are created for 3 to 30 program groups.

3. Arrangement for performing the method according to claim 1, comprising a TV-receiver with a DVB-unit, which has data processing ability and data storage capability, where a series of main programs, and in between these, a multiplicity of inserted, relatively short duration secondary programs are received, characterized in that the TV-receiver is arranged to choose a secondary program for presentation by a receiver, on the basis of information concerning user interests and/or the demographic user profile submitted by the individual user, as it includes circuits for program storage and processing.

4. Arrangement according to claim 3, characterized in that it comprises a central control unit (24) for transmission of control programs to the receivers (21).

5. Arrangement according to claim 4, characterized in that on at least one point in a transmission system, there is placed a coding unit (25) that produces or co-ordinates codes for the secondary programs.

6. Arrangement according to claim 4, characterized in that the receiver (21) includes circuits for storing received secondary programs.

7. Arrangement according to claim 5, wherein the receiver (21) includes circuits for storing received secondary programs.
